(19) United States
(12) Patent Application Publication
(10) Pub. No.: US 2025/0342566 A1
(43) Pub. Date: Nov. 6, 2025

(54) INFORMATION PROCESSING DEVICE AND INFORMATION PROCESSING METHOD

(71) Applicant: CANON KABUSHIKI KAISHA, Tokyo (JP)

(72) Inventor: ATSUSHI FUKUDA, Kanagawa (JP)

(21) Appl. No.: 19/272,638

(22) Filed: Jul. 17, 2025

Related U.S. Application Data
(63) Continuation of application No. PCT/JP2023/040091, filed on Nov. 7, 2023.

(30) Foreign Application Priority Data
Feb. 3, 2023 (JP) 2023-015306

(51) Int. Cl. G06T 5/50; G06T 5/92; G06T 11/60

(52) U.S. Cl. CPC G06T 5/50; G06T 5/92; G06T 11/60; G06T 2210/32

(57) ABSTRACT

An information processing device executes image processing of generating a plurality of developed images by performing development processing on the plurality of RAW images, and executes recording control processing of generating one file including the plurality of RAW images, information of the plurality of RAW images, and the plurality of developed images, and record the file in a storage medium, wherein in the image processing, it is capable of generating a synthesized image having gradation properties different from gradation properties of the plurality of developed images by performing synthesis processing of the plurality of RAW images or the plurality of developed images, and in the recording control processing, a synthesized image after the synthesis processing and after the development processing is recorded in the one file, but a synthesized RAW image generated by the synthesis processing of the plurality of RAW images is not recorded.

### CROSS-REFERENCE TO RELATED APPLICATIONS

This application is a Continuation of International Patent Application No. PCT/JP2023/040091, filed Nov. 7, 2023, which claims the benefit of Japanese Patent Application No. 2023-015306, filed Feb. 3, 2023, both of which are hereby incorporated by reference herein in their entirety.

### BACKGROUND

### Field of the Technology

The present disclosure relates to an information processing device and an information processing method, and particularly, relates to a technology for obtaining an image with a wide dynamic range by synthesizing a plurality of images.

### Description of the Related Art

There is a dual gain output (DGO) sensor as an imaging element used in an imaging device such as a digital single-lens reflex camera, a digital still camera, and a digital video camera. The DGO sensor amplifies and attenuates an output signal with two gains in a column circuit to which the output signal from one pixel (photoelectric conversion element) is input, and can output two images having different brightness.

Here, a case where high dynamic range (HDR) synthesis is performed is considered. The HDR synthesis is image processing of synthesizing a plurality of standard dynamic range (SDR) images having different brightness to obtain an HDR image. The DGO sensor can output two images having different brightness in one exposure. Thus, in a case where two images obtained by time-division exposure (two times of exposure) are synthesized, alignment processing of the two images is required. However, in a case where the two images obtained by the DGO sensor are synthesized, the alignment processing is not required. Thus, the DGO sensor is compatible with the HDR synthesis.

Japanese Patent Laid-Open No. 2005-323162 discloses recording (storing) one file including two RAW images in a storage medium. Due to the use of this technology, after photographing, development processing is performed on two RAW images by freely changing parameters of image processing such as exposure adjustment, white balance adjustment, optical correction, and noise reduction, and two images obtained by the development processing can be synthesized.

However, with the technology disclosed in Japanese Patent Laid-Open No. 2005-323162, it is not possible to easily specify what kind of RAW images a plurality of RAW images included in one file are.

### SUMMARY

The present disclosure provides a technique that is capable of easily specifying what kind of RAW images a plurality of RAW images included in one file are.

An information processing device according to the present disclosure a processor, and a memory storing a program which, when executed by the processor, causes the information processing device to execute acquisition processing of acquiring a plurality of RAW images having different brightness, execute image processing of generating a plurality of developed images by performing development processing on the plurality of RAW images, and execute recording control processing of generating one file including the plurality of RAW images, information of the plurality of RAW images, and the plurality of developed images, and record the file in a storage medium, wherein in the image processing, it is capable of generating a synthesized image having gradation properties different from gradation properties of the plurality of developed images by performing synthesis processing of the plurality of RAW images or the plurality of developed images, and in the recording control processing, a synthesized image after the synthesis processing and after the development processing is recorded in the one file, but a synthesized RAW image generated by the synthesis processing of the plurality of RAW images is not recorded.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a configuration of an imaging device.

FIG. 2 is a block diagram illustrating a configuration of an imaging element.

FIG. 3 is a circuit diagram illustrating a configuration of a pixel unit.

FIG. 4 is a block diagram illustrating a configuration related to HDR synthesis.

FIGS. 5A to 5C are graphs representing a relationship between an input light amount of the imaging element and brightness of a developed image.

FIG. 6 is a flowchart illustrating recording processing according to the first embodiment.

FIG. 7 is a schematic diagram of a structure of a file.

FIGS. 8A to 8D are schematic diagrams illustrating ImageData.

FIG. 9 is a flowchart illustrating reproduction processing according to a second embodiment.

FIG. 10 is a flowchart illustrating reproduction processing according to a third embodiment.

### DESCRIPTION OF THE EMBODIMENTS

### First Embodiment

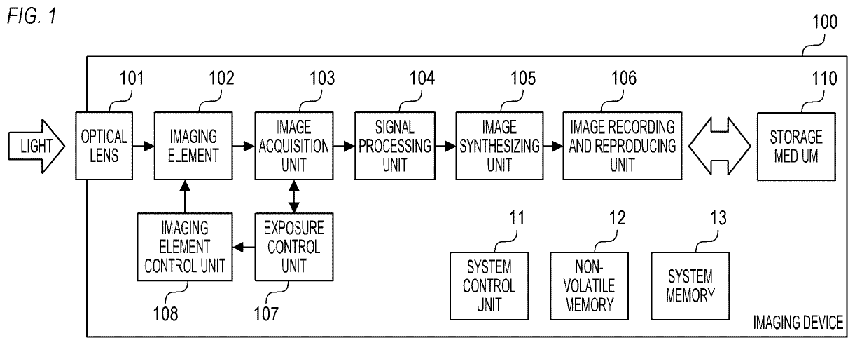

A first embodiment of the present disclosure will be described. FIG. 1 is a block diagram illustrating a configuration of an imaging device 100 according to the first embodiment.

A system control unit 11 controls the entire imaging device 100. A non-volatile memory 12 is an electrically erasable and recordable memory, and is, for example, an electrically erasable programmable read-only memory (EEPROM). The non-volatile memory 12 stores a constant, a program, and the like for an operation of the system control unit 11. The system memory 13 is, for example, a random access memory (RAM). The system memory 13 stores various kinds of information such as constants and variables for operations of the system control unit 11 and a program read from the non-volatile memory 12. Each processing to be described later is realized by the system control unit 11 by loading the program stored in the non-volatile memory 12 into the system memory 13 and executing the program.

An optical lens 101 forms an image of light from an object on an imaging element 102. The imaging element 102 converts light from the optical lens 101 into an electric signal and outputs the electric signal. The imaging element 102 is, for example, a charge coupled device (CCD) image sensor or a complementary metal oxide semiconductor (CMOS) image sensor. The imaging element 102 may be an imaging element that outputs an analog signal as a video signal. The imaging element 102 may internally perform analog-to-digital (AD) conversion and may output digital data such as a low voltage differential signaling (LVDS) signal as a video signal.

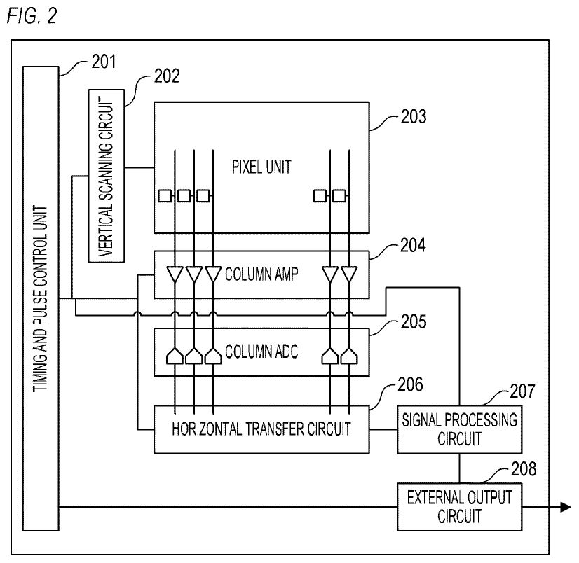

FIG. 2 is a block diagram illustrating a configuration of the imaging element 102

A timing and pulse control unit 201 controls an operation of the imaging element 102 by supplying an operation clock to each unit of the imaging element 102 or supplying a timing signal to each unit.

A vertical scanning circuit 202 performs timing control for reading a video signal from a pixel unit 203. The pixel unit 203 includes a plurality of photoelectric conversion elements (a plurality of pixels) disposed two-dimensionally (for example, a matrix shape). The photoelectric conversion element converts light incident on the photoelectric conversion element into a voltage (pixel signal voltage). The timing control performed by the vertical scanning circuit 202 is timing control for sequentially reading pixel signal voltages from the plurality of photoelectric conversion elements in one frame period. In general, the pixel signal voltage is read every row from an upper row to a lower row of the pixel unit 203.

A column amplifier (AMP) 204 electrically amplifies the video signal read from the pixel unit 203. As a result, a difference between a level of the video signal output from the column AMP 204 and a level of noise output from a column analog-to-digital converter (ADC) 205 increases. As a result, a signal-to-noise (SN) ratio of the video signal output from the column ADC is improved.

The timing and pulse control unit 201 can change a gain (amplification factor) of the column AMP 204. The column AMP 204 has two input memories and can output two video signals having different gains. Two input memories are used, and thus, two video signals corresponding to the same time can be obtained as the two video signals having different gains. Note that, the column AMP 204 may be able to output three or more video signals corresponding to the same time.

The column ADC 205 converts the analog signal, which is the video signal output (read) from the column AMP 204, into a digital signal (digital data) by AD conversion.

A horizontal transfer circuit 206 reads the digitized video signal from the column ADC 205 and outputs the video signal to a signal processing circuit 207.

The signal processing circuit 207 is a circuit that performs digital processing (digital signal processing), performs digital processing on the video signal output from the horizontal transfer circuit 206, and outputs the video signal after the digital processing to an external output circuit 208. For example, the signal processing circuit 207 can perform, as the digital processing, offset processing of adding a predetermined value and gain processing of multiplying the predetermined value. In a case where the pixel unit 203 has a pixel region (light shielding region) intentionally shielded from light, the signal processing circuit 207 may perform, as the digital processing, black level clamp processing using a video signal of the light shielding region.

The external output circuit 208 has a serializer function, and converts a multi-bit parallel signal which is the video signal output from the signal processing circuit 207 into a serial signal. Then, the external output circuit 208 converts the obtained serial signal into a video signal of a predetermined system (for example, LVDS signal), and outputs the video signal to an outside (for example, image acquisition unit 103 of FIG. 1).

The description refers back to FIG. 1. The image acquisition unit 103 performs various kinds of processing on the video signal output from the imaging element 102. For example, in a case where AD conversion is not performed inside the imaging element 102, the image acquisition unit 103 has an analog front end and performs AD conversion on the video signal output from the imaging element 102. The image acquisition unit 103 may perform various kinds of processing such as removal of fixed pattern noise of the imaging element 102 and black level clamp processing. The image acquisition unit 103 may separate the video signal output from imaging element 102 into a video signal for recording and a signal for control (for example, a signal for controlling the imaging element 102). In the first embodiment, the image acquisition unit 103 outputs the video signal for recording to a signal processing unit 104, and outputs the signal for control to an exposure control unit 107.

The signal processing unit 104 performs various kinds of processing including development processing on the video signal (RAW image) output from the image acquisition unit 103. Hereinafter, the image after the development processing is referred to as a developed image. Then, the signal processing unit 104 outputs the video signal after the processing (developed image) to an image synthesizing unit 105. For example, the signal processing unit 104 performs at least one of pixel addition, noise reduction, gamma correction, knee correction, digital gain processing, and scratch correction.

Further, the image acquisition unit 103 and the signal processing unit 104 include a storage circuit that stores setting values necessary for various kinds of processing.

The image synthesizing unit 105 acquires, from the signal processing unit 104, a plurality of developed images (video signals of the plurality of developed images), respectively, corresponding to a plurality of (for example, two) RAW images output from the imaging element 102, and synthesizes the plurality of developed images. As a result, a synthesized image (a video signal of the synthesized image) having different gradation properties from gradation properties of the plurality of developed images is generated. For example, the image synthesizing unit 105 performs image processing (HDR synthesis) of synthesizing a plurality of standard dynamic range (SDR) images having different brightness to obtain a high dynamic range (HDR) image. Then, the image synthesizing unit 105 outputs the video signal of the synthesized image to an image recording and reproducing unit 106.

The image recording and reproducing unit 106 generates one file including a plurality of (for example, two) RAW images output from the imaging element 102, and records the generated file in a storage device that is an external device of the imaging device 100 or a storage medium 110 provided in the imaging device 100. In the first embodiment, the image recording and reproducing unit 106 also stores the synthesized image output from the image synthesizing unit 105 in a file. The image recording and reproducing unit 106 can also reproduce an image (display an image on a display unit (not illustrated)) based on the file recorded in the storage device or the storage medium 110. The storage medium 110 may be built in the imaging device 100 or may be detachable from the imaging device 100.

The exposure control unit 107 calculates an optimum exposure amount based on the signal (signal for control) output from the image acquisition unit 103, and outputs a calculation result to an imaging element control unit 108.

The imaging element control unit 108 controls the imaging element 102 according to the optimum exposure amount output from the exposure control unit 107.

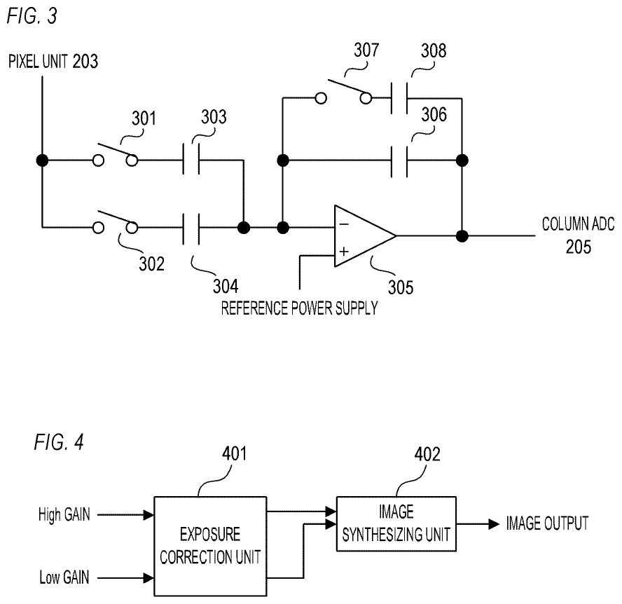

FIG. 3 is a circuit diagram illustrating a configuration of a portion of the column AMP 204 corresponding to one column of the pixel unit 203. The circuit of FIG. 3 includes switch (SW) 301, SW 302, capacitance (C) 303, C 304, operational amplifier (OP) 305, SW 307, C 308, and C 309. The SW 301 is an operational amplifier. A ratio (input capacitance/feedback capacitance) between an input capacitance and a feedback capacitance connected to the OP 305 is a gain (amplification factor) of the OP 305. For example, when the SW 301 is closed and the SW 302 is opened, the C 303 is connected, as the input capacitance, to the OP 305, and when the SW 301 is opened and the SW 302 is closed, the C 304 is connected, as the input capacitance, to the OP 305. When the SW 307 is opened, the C 306 is connected, as the feedback capacitance, to the OP 305, and when the SW 307 is closed, a synthesized capacitance of the C 306 and the C 308 is connected, as the feedback capacitance, to the OP 305. Accordingly, a gain of the OP 305 can be switched (changed) by switching open or close states of the SWs 301, 302, and 307. The OP 305 amplifies the video signal (RAW image) read from the pixel unit 203 with a gain corresponding to the open or close states of the SWs 301, 302, and 307, and outputs the amplified video signal (RAW image) to the column ADC 205. The gain of the OP 305 is sequentially switched, and thus, the brightness of the video signal (RAW image) read from the pixel unit 203 is sequentially changed with a plurality of gains. As a result, a plurality of video signals having different gains (a plurality of RAW images having different brightness) is obtained.

FIG. 4 is a block diagram illustrating a configuration related to the synthesis (for example, HDR synthesis) of the plurality of developed images. Here, it is assumed that an H-developed image that is a developed image obtained with a high gain higher than a normal gain and an L-developed image that is a developed image obtained with a low gain lower than the normal gain are synthesized. An exposure correction unit 401 is a part of the signal processing unit 104, and adjusts the brightness of the H-developed image and the brightness of the L-developed image such that the brightness of the synthesized image linearly increases with respect to an increase in an input light amount (actual brightness of the object) of the imaging element 102. An image synthesizing unit 402 is the image synthesizing unit 105, and generates a synthetic image by synthesizing the H-developed image and the L-developed image after the brightness adjustment.

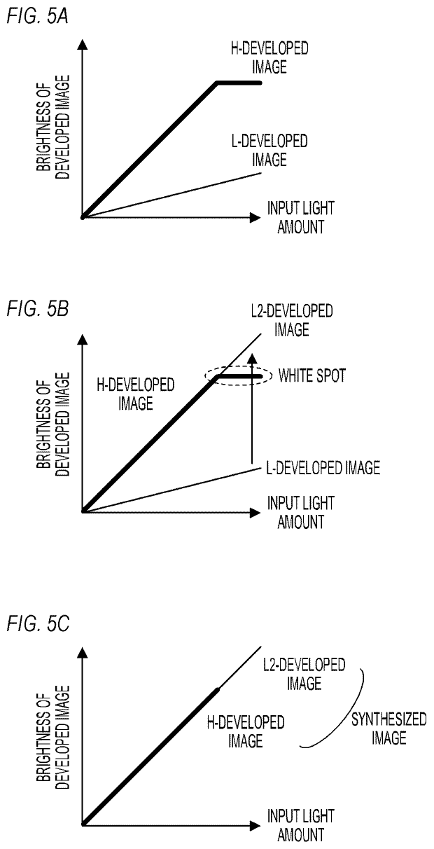

FIGS. 5A to 5C are graphs in which the input light amount of the imaging element 102 is on a horizontal axis and the brightness of the developed image is on a vertical axis.

A thick line of FIG. 5A indicates a correspondence relationship between the input light amount of the imaging element 102 and the brightness of the H-developed image, and a thin line of FIG. 5A indicates a correspondence relationship between the input light amount of the imaging element 102 and the brightness of the L-developed image. As illustrated in FIG. 5A, the correspondence relationship (thick line) of the H-developed image and the correspondence relationship (thin line) of the L-developed image are greatly different. Thus, the H-developed image and the L-developed image cannot be synthesized as they are.

Thus, the exposure correction unit 401 of FIG. 4 adjusts the brightness of the H-developed image and the brightness of the L-developed image. For example, as illustrated in FIG. 5B, the exposure correction unit 401 applies (multiplies) a gain larger than 1 to the L-developed image to obtain an L2-developed image matching the brightness of the H-developed image.

Then, the image synthesizing unit 402 of FIG. 4 synthesizes the H-developed image and the L2-developed image. For example, as illustrated in FIG. 5C, the image synthesizing unit 402 generates the synthesized image by replacing a white spot region of the H-developed image with the L2-developed image.

Note that, a method for generating the synthesized image is not limited to the above method. For example, a gain smaller than 1 may be applied to the H-developed image to obtain an H2-developed image matching the brightness of the L-developed image. Then, the synthesized image may be generated by replacing a black spot region of the L-developed image with the H2-developed image. The H2-developed image and the L-developed image may be synthesized. Both the brightness of the H-developed image and the brightness of the L-developed image may be adjusted to synthesize the H-developed image after the brightness adjustment and the L-developed image after the brightness adjustment. An appropriate-developed image that is a developed image obtained with a normal gain may be used instead of the H-developed image or the L-developed image. Three or more developed images, respectively, corresponding to three or more RAW images may be synthesized. In addition, although an example in which the synthesized image by synthesizing the plurality of developed images is generated has been described, a synthesized image in a RAW format may be generated by synthesizing a plurality of RAW images, and development processing may be performed on the synthesized image. The method (synthesis algorithm) is not particularly limited as long as it is possible to generate a synthesized image having gradation properties different from gradation properties of a plurality of images (a plurality of RAW images or a plurality of developed images) by synthesizing the plurality of images.

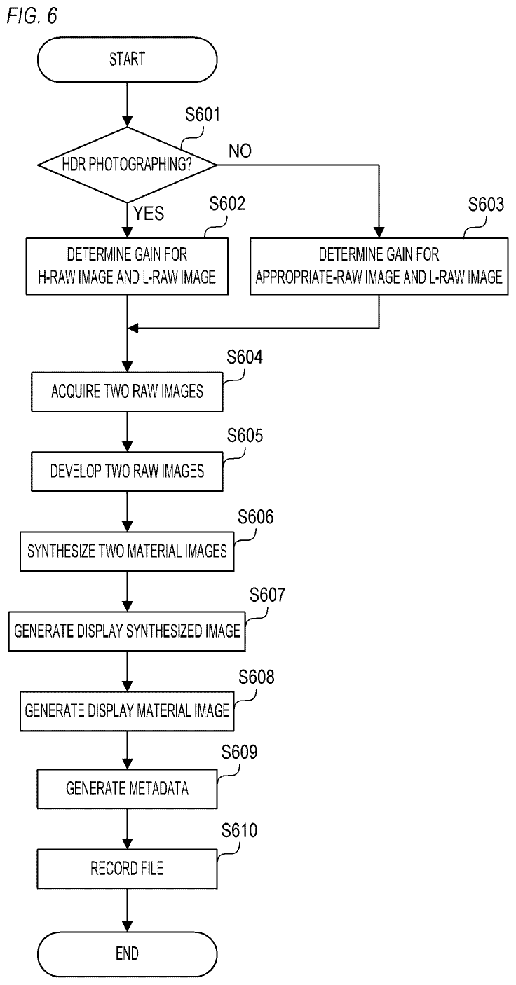

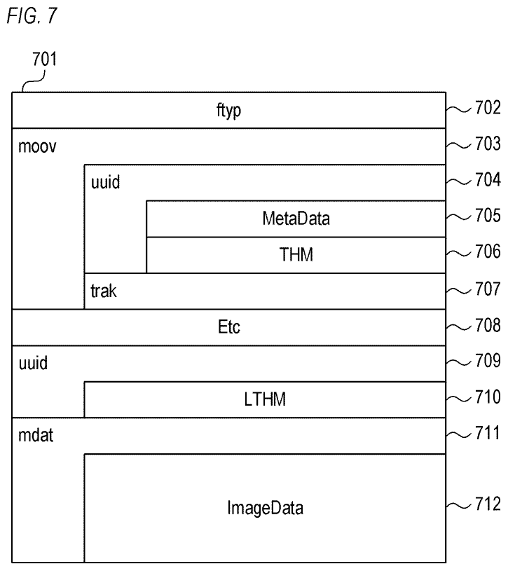

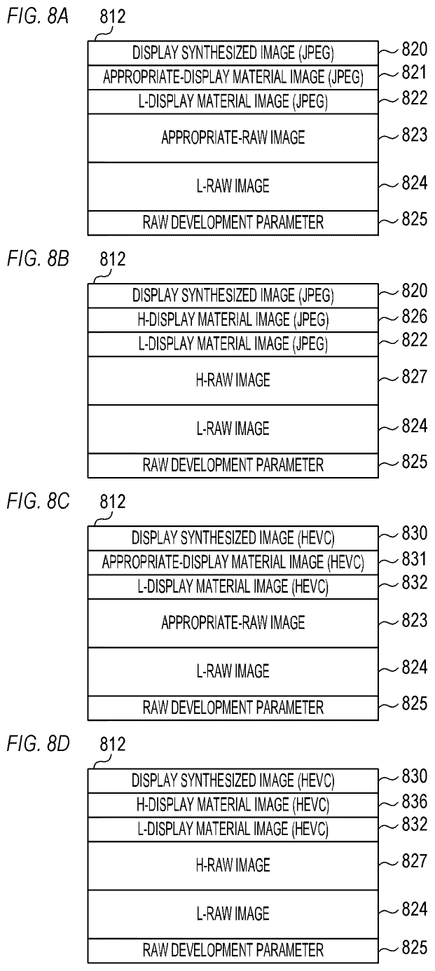

FIG. 6 is a flowchart illustrating recording processing of the imaging device 100. The recording processing of FIG. 6 is realized by the system control unit 11 loading the program stored in the non-volatile memory 12 into the system memory 13 and executing the program. The recording processing of FIG. 6 is performed, for example, in response to a photographing instruction from a user.

In step S601, the system control unit 11 determines whether or not to perform HDR photographing to obtain an HDR image as the synthesized image. The system control unit proceeds to step S602 in a case where the HDR photographing is performed, and proceeds to step S603 in a case where the HDR photographing is not performed (in a case where the SDR photographing for obtaining the SDR image as the synthesized image is performed).

In step S602, the system control unit 11 determines the gain (amplification rate or ISO sensitivity) of the imaging element 102 so as to obtain an H-RAW image and an L-RAW image. The H-RAW image is a RAW image for obtaining an H-developed image, and the L-RAW image is a RAW image for obtaining an L-developed image.

In step S603, the system control unit 11 determines the gain of the imaging clement 102 so as to obtain an appropriate-RAW image and the L-RAW image. The appropriate-RAW image is a RAW image for obtaining an appropriate-developed image.

Note that, a method for determining the gain is not limited to the above method. The system control unit 11 may determine the gain according to an instruction from the user, or may automatically determine the gain. The system control unit 11 may determine the gain according to a photographing mode. For example, the system control unit 11 may determine the gain so as to obtain the appropriate-RAW image and the L-RAW image in a still image photographing mode, and may determine the gain so as to obtain the H-RAW image and the L-RAW image in a moving image photographing mode.

In step S604, the system control unit 11 sets the gain determined in step S602 or step S603 in the imaging element 102, and acquires two RAW images having different gains (two RAW images having different brightness) by using the image acquisition unit 103. In a case where the processing of step S602 is performed, the H-RAW image and the L-RAW image are obtained, and in a case where the processing of step S603 is performed, the appropriate-RAW image and the L-RAW image are obtained. Note that, the L-RAW image is a RAW image darker than the appropriate-RAW image, and the H-RAW image is a RAW image brighter than the appropriate-RAW image. Similarly, the L-developed image is a developed image darker than the appropriate-developed image, and the H-developed image is a developed image brighter than the appropriate-developed image.

In step S605, the system control unit 11 generates the two developed images by performing development processing on the two RAW images acquired in step S604 by using the signal processing unit 104. Note that, in step S605, the brightness adjustment described with reference to FIGS. 4 and 5B is also performed. Hereinafter, the developed images generated in step S605 are referred to as material images.

In step S606, the system control unit 11 generates the synthesized image by synthesizing the two material images generated in step S605 by using the image synthesizing unit 105.

In step S607, the system control unit 11 encodes the synthesized image generated in step S606 by using the image recording and reproducing unit 106. Hereinafter, the synthesized image after the encoding is referred to as a display synthesized image (synthesized image for display). In a case where the SDR photographing is performed, for example, a display synthesized image in a Joint Photographic Experts Group (JPEG) format is obtained. In a case where the HDR photographing is performed, for example, a display synthesized image in a High Efficiency Video Codec (HEVC) format is obtained. The display synthesized image has a resolution equivalent to that of the RAW image or the material image. The system control unit 11 may generate a Large Thumbnail (LTHM) image or a Thumbnail (THM) image for simple display by encoding and resizing the synthesized image by using the image recording and reproducing unit 106.

In step S608, the system control unit 11 encodes the two material images generated in step S605 by using the image recording and reproducing unit 106. Hereinafter, the material images after the encoding are referred to as display material images (material images for display). The encoding format of the display material image may be the same as or different from that of the display synthesized image. When the encoding format of the display material image is the same as that of the display synthesized image, since the display synthesized image and the display material image can be reproduced by the same processing, the reproduction can be made highly efficient.

In step S609, the system control unit 11 generates metadata of a file recorded in the storage medium 110 by using the image recording and reproducing unit 106. The system control unit 11 stores information of the two RAW images acquired in step S604 in the metadata. The information of the two RAW images is, for example, information that can identify whether or not each of the two RAW images is any of the H-RAW image, the L-RAW image, and the appropriate-RAW image. Whether or not the RAW image is any of the H-RAW image, the L-RAW image, and the appropriate-RAW image may be indicated by a bit definition.

In step S610, the system control unit 11 generates one file (RAW image file) including the two RAW images acquired in step S604 and the metadata generated in step S609 by using the image recording and reproducing unit 106. Then, the system control unit 11 records the generated file in the storage medium 110 by using the image recording and reproducing unit 106. In the first embodiment, the system control unit 11 also stores the display synthesized image generated in step S607 and the two display material images generated in step S608 in the file recorded in the storage medium 110. The metadata is stored in, for example, a file header. The metadata may be stored in MakerNote uniquely defined by a development manufacturer of the imaging device 100.

FIG. 7 is a schematic diagram illustrating a structure of the file recorded in the storage medium 110. A container format (file format) is not particularly limited, but the file of FIG. 7 has an ISO base media file format defined by ISO/IEC14496-12. Thus, the file of FIG. 7 has a tree structure and has each node called a box. A plurality of boxes as child elements can be provided in each box.

A file 701 has ftyp 702 at the beginning and then has moov 703, uuid 709, Etc 708, and mdat 711. The ftyp 702 is a box that stores (describes) a file type. The moov 703 is a box that stores metadata. The uuid 709 is a user-defined box. The mdat 711 is a box that stores media data (image data). The Etc 708 is another box.

The moov 703 has, as child elements, uuid 704 which is a user-defined box and trak 707 which is a box that stores information to refer to ImageData 712. The uuid 704 includes, as child elements, MetaData 705 which is a box that stores metadata, and THM 706 which is a box that stores image data of a THM image. The metadata includes, for example, creation date and time of a file, photographing conditions, information on whether or not the HDR photographing or the SDR photographing is performed, information of the RAW image (appropriate-RAW image/H-RAW image/L-RAW image), and other photographing information.

The uuid 709 includes, as a child element, LTHM 710 which is a box that stores image data of an LTHM image. The mdat 711 includes, as a child element, ImageData 712 which is a box that stores pieces of image data of the RAW image, the display material image, and the display synthesized image.

The pieces of image data stored in the ImageData 712, THM 706, and LTHM 710 are different between the SDR photographing and the HDR photographing.

Note that, the structure of the file is not limited to the above structure. For example, a box different from the above box may be included in the file. At least one of the display synthesized image and the display material image may not be included in the file.

FIG. 8A is a schematic diagram illustrating ImageData 812 in a case where SDR photographing of a still image is performed. The ImageData 812 of FIG. 8A stores an appropriate-RAW image 823, an L-RAW image 824, and a RAW development parameter 825. The RAW development parameter is a parameter used for development processing of the RAW image. The ImageData 812 of FIG. 8A further stores a display synthesized image 820, an appropriate-display material image 821, and an L-display material image 822. The display synthesized image 820, the appropriate-display material image 821, and the L-display material image 822 are SDR images in the JPEG format. The appropriate-display material image 821 is a display material image corresponding to the appropriate-RAW image, and is generated by encoding the appropriate-developed image. The L-display material image 822 is a display material image corresponding to the L-RAW image, and is generated by encoding the L-developed image.

FIG. 8B is a schematic diagram illustrating ImageData 812 in a case where SDR photographing of a moving image is performed. The ImageData 812 of FIG. 8B stores an H-RAW image 827, an L-RAW image 824, and a RAW development parameter 825. The ImageData 812 of FIG. 8B further stores a display synthesized image 820, an H-display material image 826, and an L-display material image 822. Similarly to the display synthesized image 820 and the L-display material image 822, the H-display material image 826 is also an SDR image in the JPEG format. The H-display material image 826 is a display material image corresponding to the H-RAW image, and is generated by encoding the H-developed image. A moving image file can be generated by storing data of a plurality of frames in one file by using the ImageData 812 of FIG. 8B as data of one frame.

FIG. 8C is a schematic diagram illustrating ImageData 812 in a case where HDR photographing of a still image is performed. The ImageData 812 of FIG. 8C stores an appropriate-RAW image 823, an L-RAW image 824, and a RAW development parameter 825. The ImageData 812 of FIG. 8C further stores a display synthesized image 830, an appropriate-display material image 831, and an L-display material image 832. The display synthesized image 830 is an HDR image in the HEVC format, and the appropriate-display material image 831 and the L-display material image 832 are SDR images in the HEVC format. The appropriate-display material image 831 is a display material image corresponding to the appropriate-RAW image, and is generated by encoding the appropriate-developed image. The L-display material image 832 is a display material image corresponding to the L-RAW image, and is generated by encoding the L-developed image.

FIG. 8D is a schematic diagram illustrating ImageData 812 in a case where HDR photographing of a moving image is performed. The ImageData 812 of FIG. 8D stores an H-RAW image 827, an L-RAW image 824, and a RAW development parameter 825. The ImageData 812 of FIG. 8D further stores a display synthesized image 830, an H-display material image 836, and an L-display material image 832. Similarly to the L-display material image 832, the H-display material image 836 is also an SDR image in the HEVC format. The H-display material image 836 is a display material image corresponding to the H-RAW image, and is generated by encoding the H-developed image. A moving image file can be generated by storing data of a plurality of frames in one file by using the ImageData 812 of FIG. 8D as data of one frame.

As described above, according to the first embodiment, in a case where the plurality of RAW images is stored in one file, the information of the plurality of RAW images is also stored in the file. In doing so, it is possible to easily specify what kind of RAW image the plurality of RAW images included in the file is from the information included in the file. Note that, in the first embodiment, the plurality of developed images (the plurality of display material images) corresponding to the plurality of RAW images are also stored in the file. Thus, it is possible to easily specify what kind of RAW image the plurality of RAW images included in the file is from the plurality of developed images.

### Second Embodiment

A second embodiment of the present disclosure will be described. Note that, in the following description, the same description as in the first embodiment (for example, the description about the same configuration and processing as in the first embodiment) will be omitted, and differences from the first embodiment will be described.

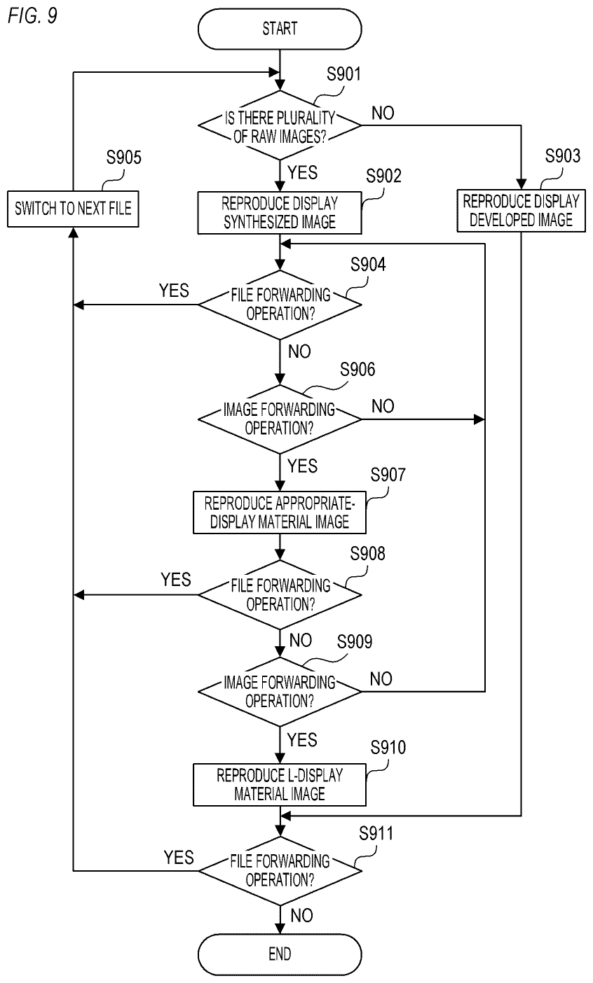

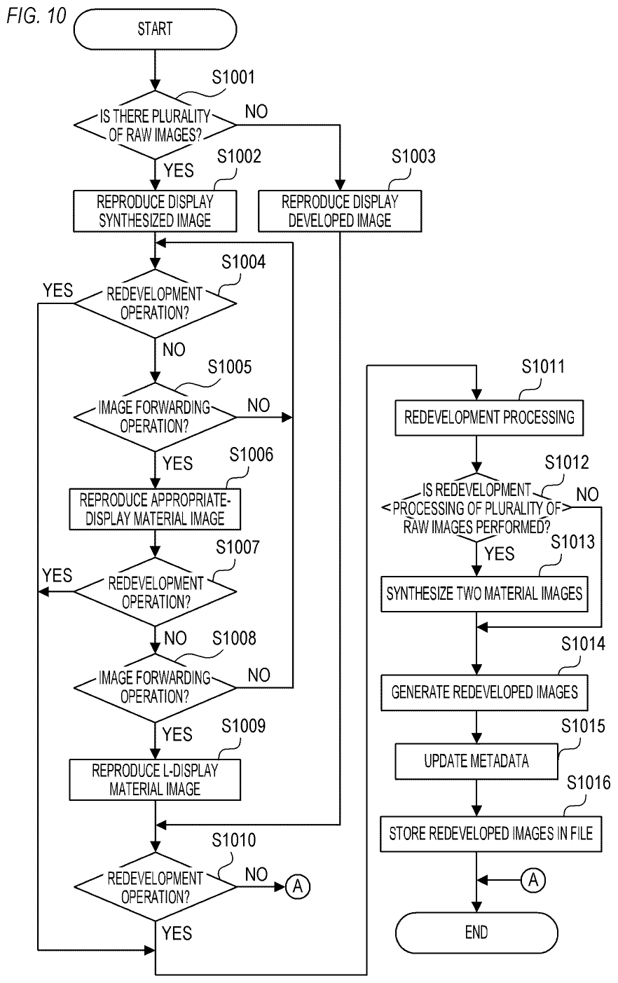

FIG. 9 is a flowchart illustrating reproduction processing of the imaging device 100. The reproduction processing of FIG. 9 is realized by the system control unit 11 loading the program stored in the non-volatile memory 12 into the system memory 13 and executing the program. The reproduction processing of FIG. 9 is performed, for example, in response to a reproduction instruction from the user. Here, it is assumed that the file including the plurality of RAW images is a file including the appropriate-RAW image and the L-RAW image.

In step S901, the system control unit 11 reads the file (RAW image file) from the storage medium 110 by using the image recording and reproducing unit 106, and determines whether or not the plurality of RAW images are included in the file. Whether or not the plurality of RAW images are included in the file can be determined based on the information included in the file (for example, MetaData 705 of FIG. 7). The system control unit proceeds to step S902 in a case where the plurality of RAW images are included in the file, and proceeds to step S903 in a case where the plurality of RAW images are not included in the file (in a case where only one RAW image is included in the file).

In step S902, the system control unit 11 reproduces (displays) the display synthesized image by using the image recording and reproducing unit 106. The display synthesized image may be included in the file or may be generated at a timing of step S902. Since there is a high possibility that the file including the plurality of RAW images is a file intended to reproduce the synthesized image, the display synthesized image is reproduced first. Although details will be described later, the plurality of images including the display synthesized image and the plurality of display material images can be reproduced.

In step S903, the system control unit 11 reproduces (displays) the display developed image (developed image for display) generated by performing the development processing on the RAW image included in the file by using the image recording and reproducing unit 106. The display developed image may be included in the file or may be generated at a timing of step S903.

In step S904, the system control unit 11 determines whether or not a file forwarding operation (a user operation for switching a target file for reproducing an image) is performed. The system control unit proceeds to step S905 in a case where the file forwarding operation is performed, and proceeds to step S906 in a case where the file forwarding operation is not performed.

In step S905, the system control unit 11 switches the target file for reproducing the image to another file. Then, the system control unit proceeds to step S901.

In a case where the file forwarding operation is performed in a state where the display material image is being reproduced and the file after the switching includes the plurality of RAW images, the display material image of the file after the switching may be reproduced in step S902. At this time, the display material image corresponding to the same gain as the display material image reproduced before the switching of the file may be reproduced. For example, in a case where the L-display material image is reproduced before the switching of the file, the L-display material image of the file after the switching may be reproduced. In doing so, the user can efficiently confirm the same type of image.

In the case of continuous photographing, there is a high possibility that the user wants to confirm the same type of image as compared with the case of single photographing. Thus, in step S902, the display material image of the file after the switching may be reproduced in the case of the continuous photographing, and the display synthesized image of the file after the switching may be reproduced in the case of the single photographing.

In step S906, the system control unit 11 determines whether or not an image forwarding operation (a user operation for switching the image to be reproduced without switching the file) is performed. The system control unit proceeds to step S907 in a case where the image forwarding operation is performed, and proceeds to step S904 in a case where the image forwarding operation is not performed.

In step S907, the system control unit 11 reproduces (displays) the appropriate-display material image by using the image recording and reproducing unit 106. The appropriate-display material image may be included in the file or may be generated at a timing of step S907.

In step S908, the system control unit 11 determines whether or not the file forwarding operation is performed. The system control unit proceeds to step S905 in a case where the file forwarding operation is performed, and proceeds to step S909 in a case where the file forwarding operation is not performed.

In step S909, the system control unit 11 determines whether or not the image forwarding operation is performed. The system control unit proceeds to step S910 in a case where the image forwarding operation is performed, and proceeds to step S904 in a case where the image forwarding operation is not performed.

In step S910, the system control unit 11 reproduces (displays) the L-display material image by using the image recording and reproducing unit 106. The L-display material image may be included in the file or may be generated at a timing of step S910.

In step S911, the system control unit determines whether or not the file forwarding operation is performed. The system control unit proceeds to step S905 in a case where the file forwarding operation is performed, and ends the reproduction processing of FIG. 9 in a case where the file forwarding operation is not been performed.

Note that, in a case where the image forwarding operation is performed again after step S910, the system control unit 11 reproduces (displays) the display synthesized image by using the image recording and reproducing unit 106. As described above, in a case where the plurality of RAW images are included in the file, the image to be reproduced is switched between the plurality of images including the display synthesized image and the plurality of display material images in response to the image forwarding operation.

As described above, according to the second embodiment, it is possible to reproduce (display) the plurality of developed images (the plurality of display material images), respectively, corresponding to the plurality of RAW images included in the file. As a result, the user can easily specify what kind of RAW image the plurality of RAW images included in the file is.

Note that, although the example in which the imaging device 100 performs the reproduction processing has been described, a device (electronic device) separate from the imaging device 100 may perform the reproduction processing. In addition, in a case where the plurality of RAW images are included in the file, information (for example, a plurality of icons, respectively, indicating the plurality of RAW images) of the plurality of RAW images may be displayed. In a case where the plurality of RAW images are included in the file, a plurality of developed images, respectively, corresponding to the plurality of RAW images may be displayed side by side in response to a predetermined user operation. For example, the appropriate-display material image and the L-display material image may be displayed side by side. In a case where the plurality of RAW images are included in the file, the synthesized image and the plurality of developed images, respectively, corresponding to the plurality of RAW images may be displayed side by side in response to a predetermined user operation. For example, the display synthesized image, the appropriate-display material image, and the L-display material image may be displayed side by side in a left-right direction.

### Third Embodiment

A third embodiment of the present disclosure will be described. Note that, in the following description, the same description as in the first embodiment and the second embodiment (for example, the description about the same configuration and processing as in the first embodiment and the second embodiment) will be omitted, and differences from the first embodiment and the second embodiment will be described.

FIG. 10 is a flowchart illustrating reproduction processing of the imaging device 100. The reproduction processing of FIG. 10 is realized by the system control unit 11 developing the program stored in the non-volatile memory 12 into the system memory 13 and executing the program. The reproduction processing of FIG. 10 is performed, for example, in response to a reproduction instruction from the user. Here, it is assumed that the file including the plurality of RAW images is a file including the appropriate-RAW image and the L-RAW image.

Similarly to step S901 in FIG. 9, in step S1001, the system control unit 11 reads the file (RAW image file) from the storage medium 110 by using the image recording and reproducing unit 106, and determines whether or not the plurality of RAW images are included in the file. The system control unit proceeds to step S1002 in a case where the plurality of RAW images are included in the file, and proceeds to step S1003 in a case where the plurality of RAW images are not included in the file (in a case where only one RAW image is included in the file).

Similarly to step S902, in step S1002, the system control unit 11 reproduces (displays) the display synthesized image by using the image recording and reproducing unit 106.

Similarly to step S903, in step S1003, the system control unit 11 reproduces (displays) the display developed image by using the image recording and reproducing unit 106.

In step S1004, the system control unit 11 determines whether or not a redevelopment operation (a user operation for performing development processing (redevelopment processing) by using a RAW development parameter newly designated by the user) is performed. The system control unit proceeds to step S1011 in a case where the redevelopment operation is performed, and proceeds to step S1005 in a case where the redevelopment operation is not performed.

Similarly to step S906, in step S1005, the system control unit 11 determines whether or not the image forwarding operation is performed. The system control unit proceeds to step S1006 in a case where the image forwarding operation is performed, and proceeds to step S1004 in a case where the image forwarding operation is not performed.

Similarly to step S907, in step S1006, the system control unit 11 reproduces (displays) the appropriate-display material image by using the image recording and reproducing unit 106.

In step S1007, the system control unit 11 determines whether or not the redevelopment operation is performed. The system control unit proceeds to step S1011 in a case where the redevelopment operation is performed, and proceeds to step S1008 in a case where the redevelopment operation is not performed.

Similarly to step S909, in step S1008, the system control unit 11 determines whether or not the image forwarding operation is performed. The system control unit proceeds to step S1009 in a case where the image forwarding operation is performed, and proceeds to step S1004 in a case where the image forwarding operation is not performed.

Similarly to step S910, in step S1009, the system control unit 11 reproduces (displays) the L-display material image by using the image recording and reproducing unit 106.

In step S1010, the system control unit 11 determines whether or not the redevelopment operation is performed. The system control unit proceeds to step S1011 in a case where the redevelopment operation is performed, and ends the reproduction processing of FIG. 10 in a case where the redevelopment operation is not performed.

In step S1011, the system control unit 11 performs the redevelopment processing of the RAW image by using the newly designated RAW development parameter. The redevelopment processing is performed by using the signal processing unit 104. For example, in a case where the redevelopment operation is performed in a state where the display synthesized image is being reproduced, the redevelopment processing (for example, the redevelopment processing of the appropriate-RAW image and the L-RAW image) of the plurality of RAW images is performed. In a case where the redevelopment operation is performed in a state where the display material image is being reproduced, the redevelopment processing of the RAW image corresponding to the display material image is performed. For example, in a case where the redevelopment operation is performed in a state where the appropriate-display material image is being reproduced, the redevelopment processing of the appropriate-RAW image is performed. In a case where the redevelopment operation is performed in a state where the L-display material image is being reproduced, the redevelopment processing of the L-RAW image is performed. In a case where only one RAW image is included in the file, the redevelopment processing of the one RAW image is performed.

In step S1012, the system control unit 11 determines whether or not the redevelopment processing of the plurality of RAW images is performed in step S1011. The system control unit proceeds to step S1013 in a case where the redevelopment processing of the plurality of RAW images is performed, and proceeds to step S1014 in a case where the redevelopment processing of the plurality of RAW images is not performed (in a case where the redevelopment processing of one RAW image is performed).

Similarly to step S606 of FIG. 6, in step S1013, the system control unit 11 generates the synthesized image by synthesizing the plurality of developed images (the plurality of material images) generated in step S1011 by using the image synthesizing unit 105.

Similarly to steps S607 and S608 of FIG. 6, in step S1014, the system control unit 11 encodes the image by using the image recording and reproducing unit 106. The image after the encoding is hereinafter referred to as a redeveloped image. The system control unit encodes the synthesized image generated in step S1013 in a case where the redevelopment processing of the plurality of RAW images is performed, and encodes the developed image generated in step S1011 in a case where the redevelopment processing of the plurality of RAW images is not performed (in a case where the redevelopment processing of one RAW image is performed). Then, the system control unit 11 updates the image to be reproduced to the redeveloped image by using the image recording and reproducing unit 106.

In step S1015, the system control unit 11 updates the metadata of the file by using the image recording and reproducing unit 106. For example, the system control unit 11 adds information of the redevelopment processing (for example, execution date and time of the redevelopment processing) to the metadata.

In step S1016, the system control unit 11 stores the redeveloped image (and the RAW development parameter corresponding to the redeveloped image) in the file by using the image recording and reproducing unit 106. The redeveloped image may be added to the file, or the image stored in the file may be replaced with the reproduced image. For example, in a case where redevelopment processing of the plurality of RAW images is performed, the display synthesized image stored in the file may be replaced with the reproduced image. In a case where the redevelopment processing of only the appropriate-RAW image is performed, the appropriate-display material image stored in the file may be replaced with the reproduced image. In a case where the redevelopment processing of only the L-RAW image is performed, the L-display material image stored in the file may be replaced with the reproduced image.

As described above, according to the third embodiment, an image required by the user can be obtained by the redevelopment processing.

The above-described various types of control described as being performed by the system control unit 11 may be performed by at least one piece of hardware (for example, at least one processor and/or at least one circuit). One piece of hardware may control the entire device, or a plurality of pieces of hardware may share a process to control the entire device.

Although the embodiments of the present disclosure are described in detail, the present disclosure is not limited by these specific embodiments. Various forms in the range without departing from the gist of the disclosure shall also be encompassed by the present disclosure. Each of the above-described embodiments merely illustrates an embodiment of the present disclosure, and the embodiments can be combined as necessary.

In the above-described embodiment, the case where the present disclosure is applied to the imaging device (digital camera) has been described as an example, but the present disclosure is not limited to the imaging device, and can be applied to any information processing device (electronic device) capable of acquiring RAW images. For example, the present disclosure is applicable to a personal computer, a PDA, a mobile phone terminal, a portable image viewer, a printer apparatus, a digital photo frame, a music player, a game console, and an electronic book reader. The present disclosure is also applicable to a video player, a display device (including a projection device), a tablet terminal, a smartphone, an AI speaker, a home appliance, and an in-vehicle device.

According to the present disclosure, it is possible to easily specify what kind of RAW images a plurality of RAW images included in one file are.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An information processing device comprising:
a processor; and
a memory storing a program which, when executed by the processor, causes the information processing device to
execute acquisition processing of acquiring a plurality of RAW images having different brightness;
execute image processing of generating a plurality of developed images by performing development processing on the plurality of RAW images; and
execute recording control processing of generating one file including the plurality of RAW images, information of the plurality of RAW images, and the plurality of developed images, and record the file in a storage medium,
wherein in the image processing, it is capable of generating a synthesized image having gradation properties different from gradation properties of the plurality of developed images by performing synthesis processing of the plurality of RAW images or the plurality of developed images, and
in the recording control processing, a synthesized image after the synthesis processing and after the development processing is recorded in the one file, but a synthesized RAW image generated by the synthesis processing of the plurality of RAW images is not recorded.

2. The information processing device according to claim 1, wherein
the plurality of RAW images are a plurality of RAW images generated by changing brightness of one RAW image with a plurality of gains.

3. The information processing device according to claim 1, wherein
the program, when executed by the processor, further causes the information processing device to
execute control processing of determining a plurality of gains; and
execute determination processing of determining whether or not HDR photographing is performed, and
in the control processing, a gain for acquiring a bright image and a gain for acquiring a dark image are determined as the plurality of gains in a case where the determination processing determines that the HDR photographing is performed, and a gain for acquiring a dark image and a gain for acquiring an image with normal brightness are determined as the plurality of gains in a case where the determination processing determines that the HDR photographing is not performed.

4. The information processing device according to claim 1, wherein
the program, when executed by the processor, further causes the information processing device to execute determination processing of determining whether or not HDR photographing is performed, and
in the recording control processing, a RAW image brighter than appropriate brightness and a RAW image darker than appropriate brightness are recorded as the plurality of RAW images in the one file in a case where the determination processing determines that the HDR photographing is performed, and a RAW image with appropriate brightness and a RAW image darker than the appropriate brightness are recorded as the plurality of RAW images in the one file in a case where the determination processing determines that the HDR photographing is not performed.

5. The information processing device according to claim 1, wherein
in the recording control processing, the synthesized image is recorded as a thumbnail image or a display image in the one file.

6. The information processing device according to claim 1,
wherein the plurality of developed images are SDR images, and
the synthesized image is an HDR image.

7. The information processing device according to claim 1, wherein
the program, when executed by the processor, further causes the information processing device to execute reproducing processing of reproducing an image based on a file recorded in the storage medium,
in the reproducing processing, it is determined whether or not a plurality of RAW images are included in a target file for reproducing an image based on information included in the target file,
in a case where the plurality of RAW images are included in the target file,
in the reproducing processing, one of a plurality of images including
(1) a synthesized image that is generated by the development processing and the synthesis processing using the plurality of RAW images included in the target file and has gradation properties different from gradation properties of the plurality of RAW images, and
(2) a plurality of developed images generated by performing development processing on the plurality of RAW images included in the target file is first reproduced, and
in the reproducing processing, an image to be reproduced is switched among the plurality of images in response to a first user operation.

8. The information processing device according to claim 7, wherein,
in a case where the plurality of RAW images are included in the target file, in the reproducing processing, the synthesized image is first reproduced.

9. The information processing device according to claim 7,
wherein in the reproducing processing
the target file is switched to another file in response to a second user operation, and
a developed image generated by performing development processing on a RAW image included in a file after the switching is first reproduced in a case where the second user operation is performed in a state where a developed image generated by performing the development processing on a RAW image included in a file before the switching is being reproduced and a plurality of RAW images are included in the file after the switching.

10. The information processing device according to claim 7, wherein
in the reproducing processing, the image to be reproduced is updated to an image generated by using a newly designated development parameter in response to a third user operation.

11. The information processing device according to claim 10, wherein
in the reproducing processing, the image to be reproduced is updated to a new synthesized image generated by using the newly designated development parameter in response to the third user operation in a state where the synthesized image is being reproduced.

12. The information processing device according to claim 10, wherein
in the reproducing processing, the image to be reproduced is updated to a new developed image generated by using the newly designated development parameter in response to the third user operation in a state where the developed image is being reproduced.

13. The information processing device according to claim 7, wherein,
in a case where the plurality of RAW images are included in the target file, in the reproducing processing, control is performed such that information of the plurality of RAW images is displayed.

14. The information processing device according to claim 7, wherein,
in a case where the plurality of RAW images are included in the target file, in the reproducing processing, control is performed such that the plurality of developed images are displayed side by side in response to a fourth user operation.

15. The information processing device according to claim 7, wherein,
in a case where the plurality of RAW images are included in the target file, in the reproducing processing, control is performed such that the synthesized image and the plurality of developed images are displayed side by side in response to a fourth user operation.

16. An information processing device comprising:
a processor; and
a memory storing a program which, when executed by the processor, causes the information processing device to
execute reproducing processing of reproducing an image based on a file recorded in a storage medium, wherein
in a case where a plurality of RAW images are included in a target file for reproducing an image,
in the reproducing processing, one of a plurality of images including
(1) a synthesized image that is generated by development processing and synthesis processing using the plurality of RAW images included in the target file and has gradation properties different from gradation properties of the plurality of RAW images, and
(2) a plurality of developed images generated by performing development processing on the plurality of RAW images included in the target file is first reproduced, and
in the reproducing processing, an image to be reproduced is switched among the plurality of images in response to a predetermined user operation.

17. An information processing method comprising:
acquiring a plurality of RAW images having different brightness;
generating a plurality of developed images by performing development processing on the plurality of RAW images; and
generating one file including the plurality of RAW images, information of the plurality of RAW images, and the plurality of developed images, and recording the file in a storage medium,
wherein it is capable of generating a synthesized image having gradation properties different from gradation properties of the plurality of developed images by performing synthesis processing of the plurality of RAW images or the plurality of developed images, and
a synthesized image after the synthesis processing and after the development processing is recorded in the one file, but a synthesized RAW image generated by the synthesis processing of the plurality of RAW images is not recorded.

18. An information processing method comprising:
reproducing an image based on a file recorded in a storage medium; and
switching an image to be reproduced, wherein
in a case where a plurality of RAW images are included in a target file for reproducing an image,
one of a plurality of images including
(1) a synthesized image that is generated by development processing and synthesis processing using the plurality of RAW images included in the target file and has gradation properties different from gradation properties of the plurality of RAW images, and
(2) a plurality of developed images generated by performing development processing on the plurality of RAW images included in the target file is first reproduced, and
the image to be reproduced is switched among the plurality of images in response to a predetermined user operation.

19. A non-transitory computer readable medium that stores a program, wherein the program causes a computer to execute an information processing method comprising:
acquiring a plurality of RAW images having different brightness;
generating a plurality of developed images by performing development processing on the plurality of RAW images; and
generating one file including the plurality of RAW images, information of the plurality of RAW images, and the plurality of developed images, and recording the file in a storage medium,
wherein it is capable of generating a synthesized image having gradation properties different from gradation properties of the plurality of developed images by performing synthesis processing of the plurality of RAW images or the plurality of developed images, and
a synthesized image after the synthesis processing and after the development processing is recorded in the one file, but a synthesized RAW image generated by the synthesis processing of the plurality of RAW images is not recorded.

20. A non-transitory computer readable medium that stores a program, wherein the program causes a computer to execute an information processing method comprising:
reproducing an image based on a file recorded in a storage medium; and
switching an image to be reproduced, wherein
in a case where a plurality of RAW images are included in a target file for reproducing an image,
one of a plurality of images including
(1) a synthesized image that is generated by the development processing and the synthesis processing using the plurality of RAW images included in the target file and has gradation properties different from gradation properties of the plurality of RAW images, and
(2) a plurality of developed images generated by performing development processing on the plurality of RAW images included in the target file is first reproduced, and
the image to be reproduced is switched among the plurality of images in response to a predetermined user operation.
